(19) United States
(12) Patent Application Publication
(10) Pub. No.: US 2012/0160783 A1
(43) Pub. Date: Jun. 28, 2012

(54) WATER FILTRATION DEVICE AND METHOD THEREOF

(76) Inventor: CHUN-MIN LIU, Taishan Township (TW)

(21) Appl. No.: 12/978,632

(22) Filed: Dec. 27, 2010

(51) Int. Cl. B01D 33/56; B01D 35/16; C02F 1/00

(52) U.S. Cl. 210/791; 210/407; 210/332

(57) ABSTRACT

The water filtration device and method introduce raw water into a filtration barrel where the water is purified by filter elements inside the filtration barrel. A main frame is set up in the filtration barrel and a driving motor is mounted on the main frame. The driving motor engages a holding rack inside the main frame to spin at high speed. Filter elements are stacked and interleaved on the holding rack. When the filter elements require cleaning to remove the attached contaminants from the raw water, filter elements are rotated at high speed along with the holding rack so that the contaminants are thrown off by the centrifugal force. When the filter elements are cleaned, the high-speed rotation of the filter elements could be stopped and the filtration process could be continued or terminated.

### (a) TECHNICAL FIELD OF THE INVENTION

The present invention is generally related to water filtration, and more particularly to a filtration device and a related method capable of self-cleaning.

### (b) DESCRIPTION OF THE PRIOR ART

Following the industrial development, water pollution has become a serious problem and various water filtration devices are therefore provided and installed. Depending on how clean the water is required, there are various types of filtration devices at different costs. However, in general, the meshed material such as fiber cotton, active carbon, sand, etc., is most common. Water is introduced through the meshed material and, as water flows, contaminants are detained by the meshed material while purified water is consumed or collected for future use.

In a scenario where large amount of water is involved such as the water treatment plant, the contaminants would accumulate on the filter material quickly, deteriorating its filtration capability, blocking water flow, and reducing the filtration efficiency. Conventionally, the filter material as such has to be replaced periodically, so as to maintain the water filtration effect. However, the filter material itself is a pollutant, and the constant replacement would also incur significant cost, operation effort, and affect normal water supply.

Therefore, how to remove the contaminants on the filter material by an appropriate mechanism with minimized cost and effort while, in the mean time, to maintain the filtration quality and efficiency is a subject requiring further investigation.

### SUMMARY OF THE INVENTION

An objective of the present invention is to provide a water filtration method capable of self-cleaning where filter elements are spun at high speed so as to remove contaminants by centrifugal force.

Another objective of the present invention is to provide a water filtration method capable of reducing the consumption of filter elements and filtration cost.

Yet another objective of the present invention is to provide a water filtration method capable of reducing the cleaning time of the filter elements and the interruption time of water supply.

Still another objective of the present invention is to provide a water filtration device capable of rotating filter elements at high speed so as to achieve self-cleaning.

To achieve the foregoing objectives, the water filtration method contains the following steps: introducing raw water into a filtration barrel; filtering the raw water by attracting contaminants with filter elements in the filtration barrel; deciding whether the filter elements require cleaning; if yes, detaching the contaminants from the filter elements' surfaces by the centrifugal force of rotating the filter elements at high speed; deciding whether the filter elements are cleaned; if yes, stopping the high-speed rotation of the filter elements.

The filtration device contains a filtration barrel having an open top with an outlet and an inlet at an upper lateral side and at a bottom side, respectively; a main frame housed inside the filtration barrel having a bearing seat, equipped with a bearing, and a motor seat above the bearing seat; a driving motor rested upon the motor seat having a shaft to deliver torque, a holding rack having an axle coupling with the shaft so that the holding rack is engaged to spin by the driving motor; at least a filter elements positioned on the holding rack for attaching contaminants in the water and for detaching the contaminants when the filter element is spun along with the holding rack by centrifugal force.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow diagram showing the various steps of a filtration method according to an embodiment of the present invention.

FIG. 2 is a perspective break-down diagram showing the various components of a filtration device according to an embodiment of the present invention.

FIG. 3 is a perspective diagram showing the filtration device of FIG. 2 partially assembled.

FIG. 4 is a perspective diagram showing the filtration device of FIG. 2 after it is assembled.

FIG. 5 is a schematic sectional diagram showing the filtration device of FIG. 2.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

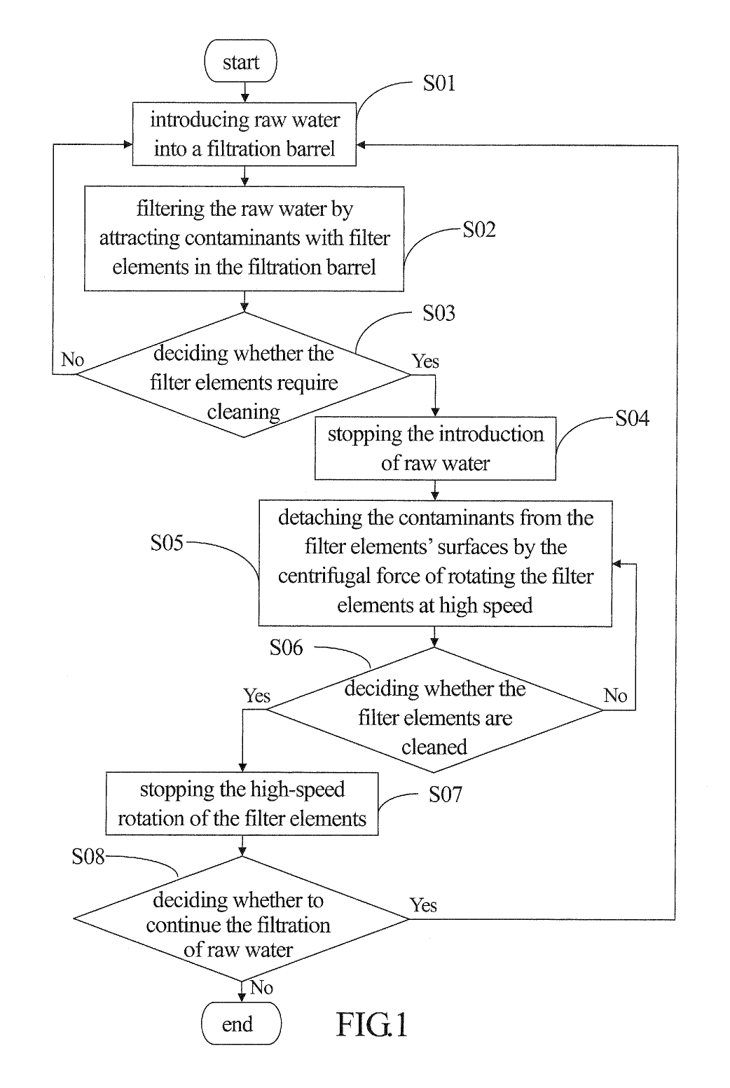

As shown in FIG. 1, a filtration method according to an embodiment of the present invention contains the following steps: introducing raw water into a filtration barrel (step S01); filtering the raw water by attracting contaminants with filter elements in the filtration barrel (step S02); deciding whether the filter elements require cleaning (step S03); stopping the introduction of raw water (step S04); detaching the contaminants from the filter elements' surfaces by the centrifugal force of rotating the filter elements at high speed (step S05); deciding whether the filter elements are cleaned (step S06); stopping the high-speed rotation of the filter elements (step S07); and deciding whether to continue the filtration of raw water (step S08).

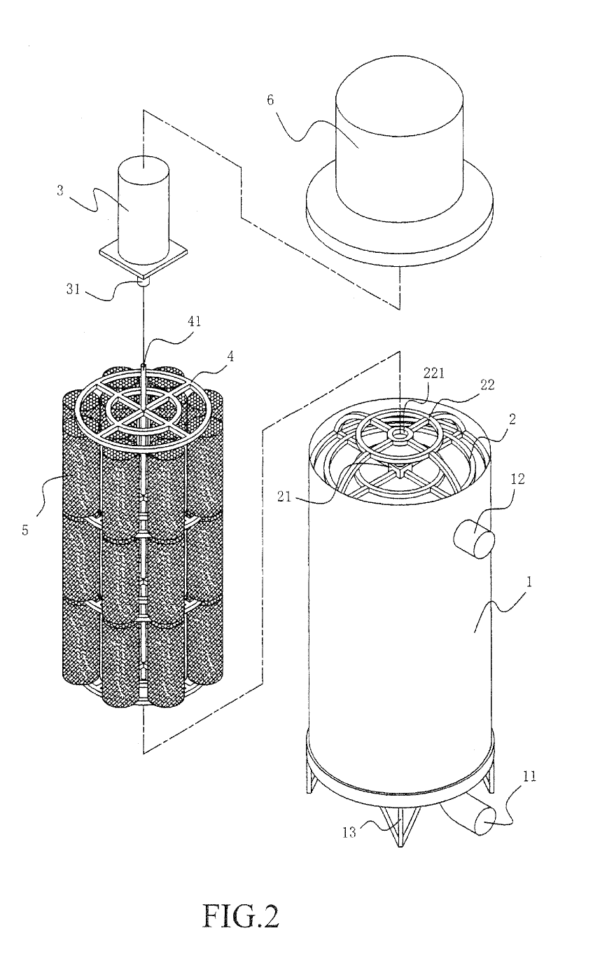

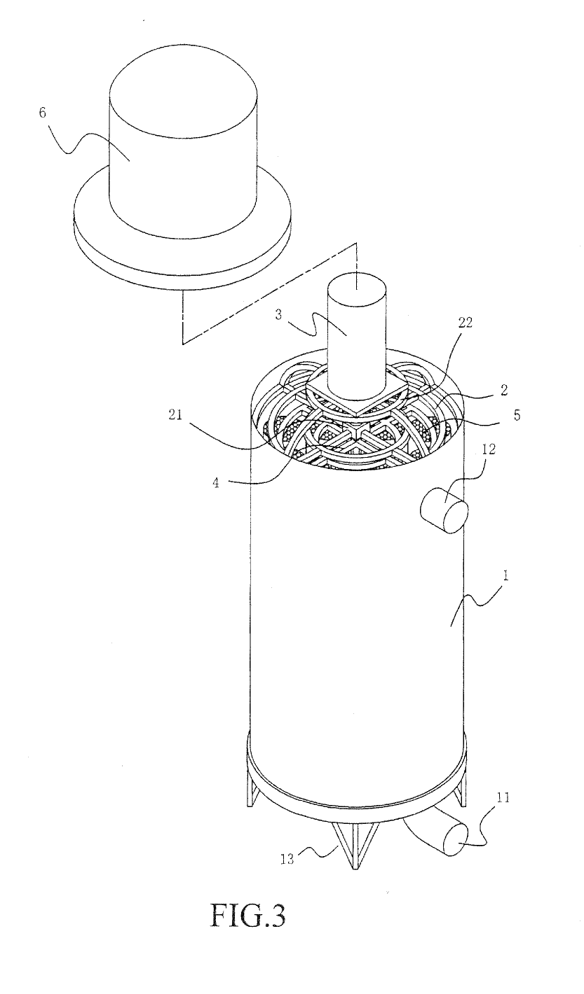

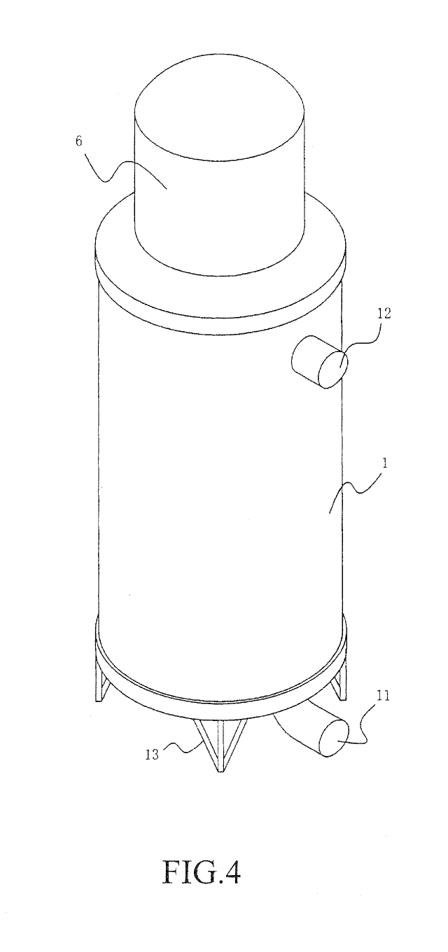

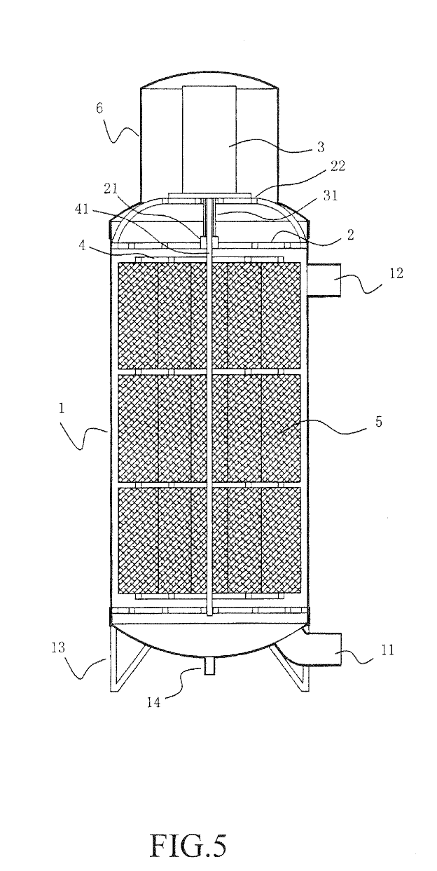

As illustrated in FIGS. 2 to 5, a filtration device according an embodiment of the present invention mainly contains a filtration barrel 1, a main frame 2, a driving motor 3, a holding rack 4, filter elements 5, and a cover 6. The filtration barrel 1, rested on a pedestal 13, has an open top with an outlet 12 and an inlet 11 at an upper lateral side and at a bottom side, respectively. The filtration barrel 1 also has a drain 14 at the center of the bottom side. The main frame 2 is housed inside the filtration barrel 1. On a top side of the main frame 2, a motor seat 22 is provided where the driving motor 2 is rested upon. In the center of the motor seat 22, a through hole 221 is configured, which is vertically aligned with a bearing seat 21, equipped with a bearing, of the main frame 2. The driving motor 3 has a shaft 31 for delivering the torque of the driving motor 3, and the shaft 31 is extended vertically downward through the through hole 221. The holding rack 4, inside the main frame 2, has an axle 41 running vertically upward through the bearing of the bearing seat 21 to couple with the shaft 31. The holding rack 4 allows a number of filter elements 5 stacked and interleaved into multiple layers so as to provide effective filtration to passing water. The cover 6 is put to seal the open top of the filtration barrel 1 which also houses the driving motor 3.

The filtration device and method operate as follows. First, in the steps S01 and S02, un-filtered or sewage water from reservoir, cultivation pond, etc., is drawn into the filtration barrel 1 through the inlet 11. As the water flows, the contaminants in the water contact with the filter elements 5 and are attached to the surfaces of the filter elements 5, thereby purifying the water. The filtered water then is drained from the outlet 12 back to the reservoir or cultivation pond. Then, in step S03, the filter elements 5 are examined by bare eye or detection equipment to see if cleaning is required. If not, the filter elements 5 are still capable of filtration and the process returns to step S01 to repeat itself.

On the other hand, if the filter elements 5 has accumulated too many contaminants by detecting the weakened filtration capability or the slow down of water flow, un-filtered or sewage water is stopped in step S04 and, by turning on the driving motor 3 in step S05, the holding rack 4, along with filter elements, is spun at high speed. The contaminants on the surfaces of the filter elements 5 are thereby shaken off by the centrifugal force, and then expelled from the drain 14. The filtration device therefore is capable of self-cleaning as described. In step S06, by the same examination by bare eye or detection equipment, the filter elements 5 are determined if they are cleaned. If not, the step S05 is repeated to further clean the filter elements 5. Otherwise, if the filter elements 5 are clean enough, step S07 stops the rotation of the filter elements 5 and step S08 decides whether to continue the filtration process. If yes, the process returns to step S01 to start all over again and, if not, the process is terminated.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A water filtration method, comprising the steps of
(a) introducing raw water into a filtration barrel;
(b) filtering raw water by attracting contaminants with filter elements in said filtration barrel;
(c) deciding whether said filter elements require cleaning and, if not, returning to step (a);
(d) detaching said contaminants from said filter elements' surfaces by the centrifugal force of rotating said filter elements at high speed;
(e) deciding whether said filter elements are cleaned and, if not, returning to step (d); and
(f) stopping the high-speed rotation of said filter elements.

2. The water filtration method according to claim 1, further comprising the following step between steps (c) and (d):
(g) stopping the introduction of raw water into said filtration barrel.

3. The water filtration method according to claim 1, further comprising the following step after step (f):
deciding whether to continue the filtration of raw water and, if not, returning to step (a).

4. The water filtration method according to claim 2, further comprising the following step after step (f):
deciding whether to continue the filtration of raw water and, if not, returning to step (a).

5. A water filtration device, comprising:
a filtration barrel having an open top with an outlet and an inlet at an upper lateral side and at a bottom side, respectively;
a main frame housed inside said filtration barrel, said main frame having a bearing seat equipped with a bearing and a motor seat above said bearing seat;
a driving motor mounted on said motor seat providing a torque;
a holding rack inside said main frame having an axle running vertically upward through said bearing of said bearing seat and coupling with said driving motor so as to be rotated by said driving motor; and
at least a filter element positioned on said holding rack for attracting contaminants in raw water flowing through, said filter element capable of detaching said contaminants by spinning at high speed along with said holding rack engaged by said driving motor.

6. The water filtration device according to claim 5, wherein said driving motor has a shaft for delivering torque and is coupled with said axle of said holding rack.

7. The water filtration device according to claim 6, wherein a through hole is configured in the center of said motor seat; and said shaft is extended downward through said through hole.

8. The water filtration device according to claim 5, wherein a drain is configured on said bottom side of said filtration barrel.

9. The water filtration device according to claim 5, further comprising a cover sealing said open top of said filtration barrel and housing said driving motor.

10. The water filtration device according to claim 5, wherein said filter elements are stacked and interleaved on said holding rack.
